(19) United States
(12) Patent Application Publication
(10) Pub. No.: US 2016/0054353 A1
(43) Pub. Date: Feb. 25, 2016

(54) PHYSICAL QUANTITY SENSOR, ELECTRONIC DEVICE, AND MOBILE BODY

(71) Applicant: Seiko Epson Corporation, Tokyo (JP)

(72) Inventor: Satoru TANAKA, Chino (JP)

(21) Appl. No.: 14/816,162

(22) Filed: Aug. 3, 2015

(30) Foreign Application Priority Data
Aug. 19, 2014 (JP) 2014-166925

(51) Int. Cl. G01P 15/125

(52) U.S. Cl. CPC G01P 15/125

(57) ABSTRACT

A physical quantity sensor includes a substrate, a support section, a movable section which is connected to the support section via linking sections, and fixed electrodes which are disposed on the substrate facing the movable section. The movable section has a first mass section, a second mass section which has a smaller mass than the first mass section, a first movable electrode which is disposed in the first mass section, and a second movable electrode which is disposed in the second mass section, the fixed electrodes include a first fixed electrode and a second fixed electrode, and when a length of the movable section in the longitudinal direction of the movable section is set as L and a length of the second mass section in the longitudinal direction of the movable section is set as L2, a relationship of 0.2≦L2/L≦0.48 is satisfied.

### BACKGROUND

1. Technical Field

The present invention relates to a physical quantity sensor, an electronic device, and a mobile body.

2. Related Art

In recent years, a physical quantity sensor which detects a physical quantity of acceleration or the like has been developed using, for example, a silicon micro electro mechanical systems (MEMS) technique.

A physical quantity sensor is known which includes a movable electrode which has a large plate section and a small plate section and is supported on an insulating layer such that the large plate section and the small plate section are able to rock in a see-saw form, a fixed electrode which is provided on the insulating layer facing the large plate section, and a fixed electrode which is provided on the insulating layer facing the small plate section (refer to JP-A-2007-298405).

The physical quantity sensor of a center anchor type described in JP-A-2007-298405 is designed to intentionally shift the position of a torsion spring from the center such that the see-saw operation is carried out without torque, which is generated by applied acceleration, being balanced.

However, in a case where the physical quantity sensor is miniaturized, efficiency of sensitivity is reduced and it is difficult for the physical quantity sensor to be highly sensitive.

### SUMMARY

An advantage of some aspects of the invention is to provide a physical quantity sensor which exhibits high sensitivity even in the case of miniaturization, and an electronic device and a mobile body that include the physical quantity sensor.

The invention can be realized in the following forms or application examples.

### APPLICATION EXAMPLE 1

According to this application example, there is provided a physical quantity sensor including: a substrate, a support section which is fixed to the substrate, a movable section which is connected to the support section via a linking section and is able to rock with respect to the support section, and fixed electrodes which are disposed on the substrate facing the movable section, in which the movable section has a first mass section which is provided on one side with respect to the linking section, a second mass section which is provided on the other side and has a smaller mass than the first mass section, a first movable electrode which is disposed in the first mass section, and a second movable electrode which is disposed in the second mass section, the fixed electrodes include a first fixed electrode which is disposed facing the first mass section and a second fixed electrode which is disposed facing the second mass section, and when a length of the movable section in the longitudinal direction of the movable section is set as L and a length of the second mass section in the longitudinal direction of the movable section is set as L2, a relationship of 0.2≦L2/L≦0.48 is satisfied.

Thereby, it is possible to provide a physical quantity sensor which exhibits high sensitivity even in the case of miniaturization.

### APPLICATION EXAMPLE 2

In the physical quantity sensor according the application example, the substrate is preferably a glass substrate.

Thereby, it is possible to provide a physical quantity sensor which exhibits higher sensitivity.

### APPLICATION EXAMPLE 3

In the physical quantity sensor according the application example, a relationship of 0.25≦L2/L≦0.44 is preferably satisfied.

Thereby, it is possible to provide a physical quantity sensor which exhibits even higher sensitivity.

### APPLICATION EXAMPLE 4

According to this application example, there is provided an electronic device including the physical quantity sensor according the application examples.

In such an electronic device, it is possible to achieve high detection sensitivity since the physical quantity sensor according to the application examples is included.

### APPLICATION EXAMPLE 5

According to this application example, there is provided a mobile body including the physical quantity sensor according the application examples.

In such a mobile body, it is possible to achieve high detection sensitivity since the physical quantity sensor according to the application examples is included.

### BRIEF DESCRIPTION OF THE DRAWINGS

The invention will be described with reference to the accompanying drawings, wherein like numbers reference like elements.

FIG. 1 is a planar diagram schematically illustrating a physical quantity sensor according to an embodiment of the invention.

FIG. 2 is a sectional diagram taken along line II-II in FIG. 1 schematically illustrating the physical quantity sensor in FIG. 1.

FIG. 3 is a sectional diagram taken along line III-III in FIG. 1 schematically illustrating the physical quantity sensor in FIG. 1.

FIG. 4 is a sectional diagram taken along line IV-IV in FIG. 1 schematically illustrating the physical quantity sensor in FIG. 1.

FIG. 5 is a sectional diagram of when 1G acceleration is applied with respect to the physical quantity sensor in FIG. 1.

FIG. 6 is a graph illustrating a relationship between L2/L and sensitivity.

FIG. 7 is a sectional diagram schematically illustrating a manufacturing process of the physical quantity sensor in FIG. 1.

FIG. 8 is a sectional diagram schematically illustrating a manufacturing process of the physical quantity sensor in FIG. 1.

FIG. 9 is a sectional diagram schematically illustrating a manufacturing process of the physical quantity sensor in FIG. 1.

FIG. 10 is a planar diagram schematically illustrating a physical quantity sensor according to a modification example of a first embodiment.

FIG. 11 is a perspective diagram illustrating a configuration of a mobile-type (or a notebook-type) personal computer to which an electronic device of the invention is applied.

FIG. 12 is a perspective diagram illustrating a configuration of a mobile phone (also including PHS) to which the electronic device of the invention is applied.

FIG. 13 is a perspective diagram illustrating a configuration of a digital still camera to which the electronic device of the invention is applied.

FIG. 14 is a perspective diagram schematically illustrating an automobile as an example of a mobile body of the invention.

### DESCRIPTION OF EXEMPLARY EMBODIMENTS

Embodiments of a physical quantity sensor, an electronic device, and a mobile body of the invention will be described below with reference to the drawings.

### Physical Quantity Sensor

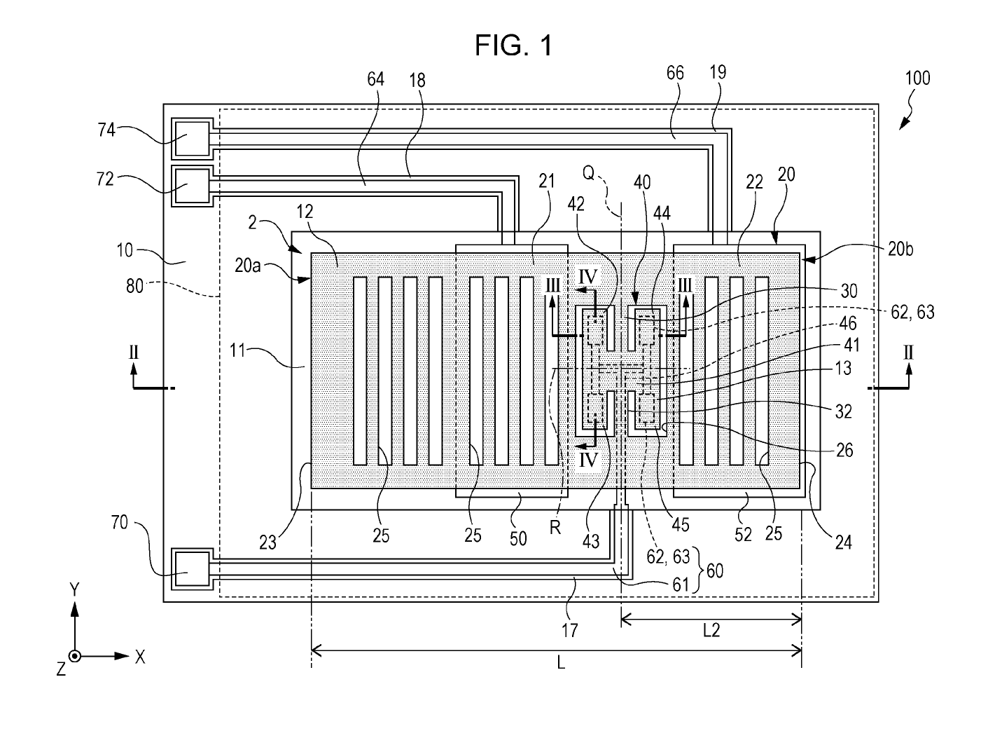

First, the physical quantity sensor in FIG. 1 will be described with reference to the drawing.

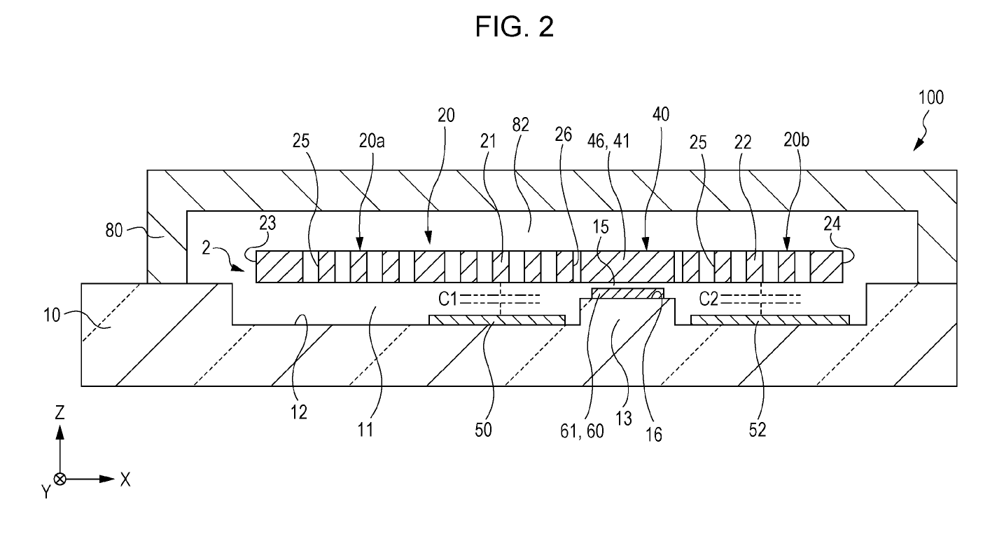

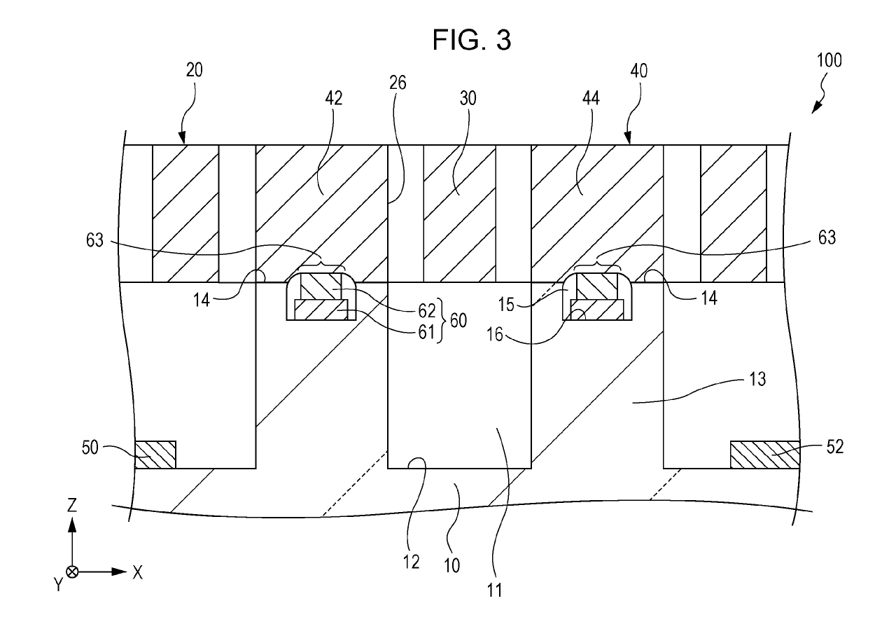

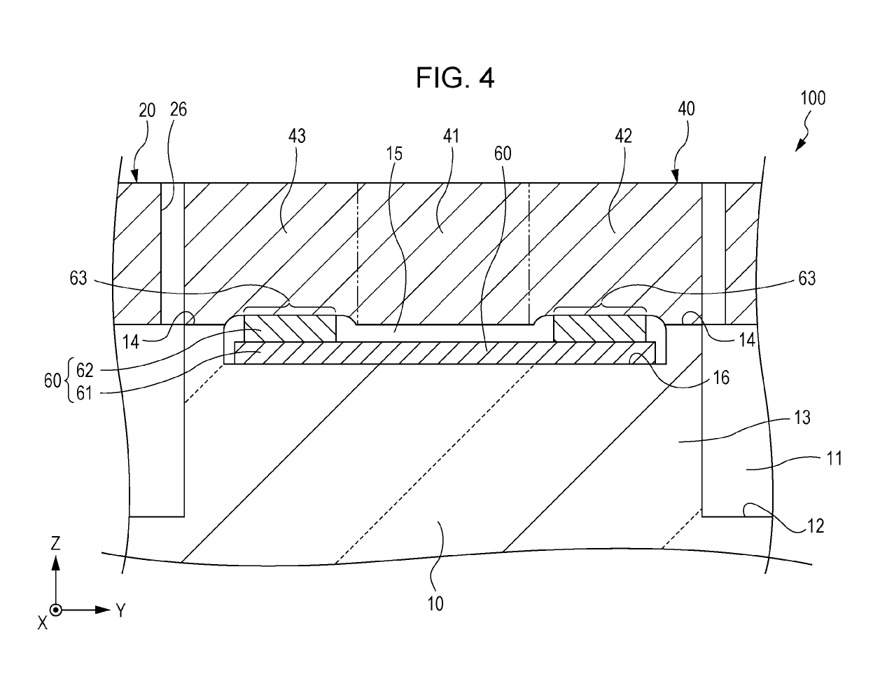

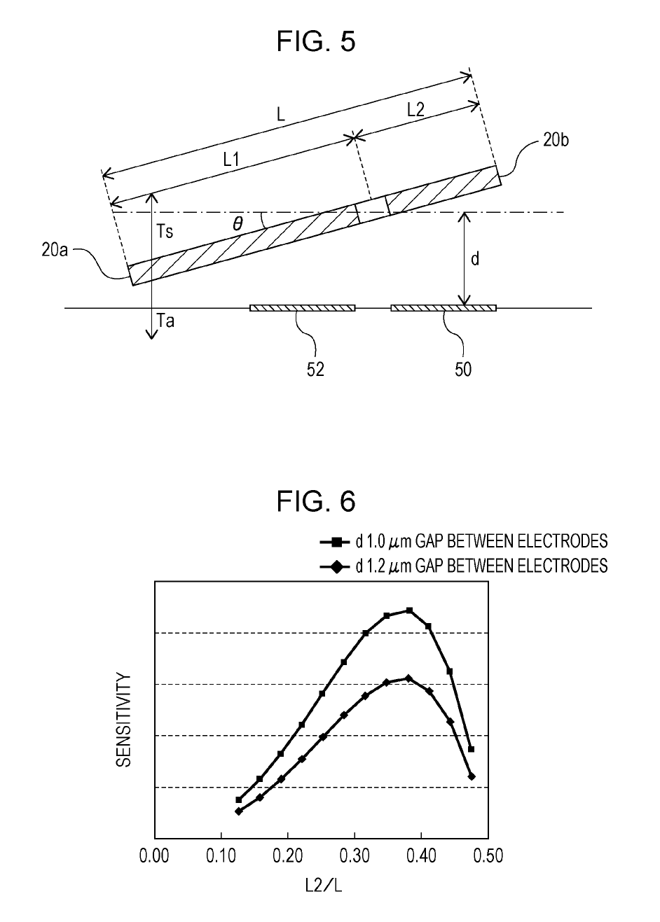

FIG. 1 is a planar diagram schematically illustrating the physical quantity sensor according to an embodiment of the invention. FIG. 2 is a sectional diagram taken along line II-II in FIG. 1 schematically illustrating a physical quantity sensor 100 in FIG. 1. FIG. 3 is a sectional diagram taken along line III-III in FIG. 1 schematically illustrating the physical quantity sensor 100 in FIG. 1. FIG. 4 is a sectional diagram taken along line IV-IV in FIG. 1 schematically illustrating the physical quantity sensor 100 in FIG. 1. In addition, FIG. 5 is a sectional diagram of when 1G acceleration is applied with respect to the physical quantity sensor in FIG. 1. FIG. 6 is a graph illustrating a relationship between L2/L and sensitivity.

Here, for convenience of explanation, in FIG. 1, a lid 80 is illustrated as being transparent. In addition, in FIG. 3 and FIG. 4, the lid 80 is omitted. In addition, in FIG. 1 to FIG. 4, the X axis, the Y axis, and the Z axis are illustrated as three axes which are orthogonal to one another.

As shown in FIG. 1 to FIG. 4, the physical quantity sensor 100 has a substrate 10, a movable section 20, linking sections 30 and 32, a support section 40, fixed electrodes 50 and 52, wirings 60, 64, and 66, pads 70, 72, and 74, and the lid 80.

Here, in the present embodiment, the physical quantity sensor 100 is described as an example of an acceleration sensor (electrostatic capacitive-type MEMS acceleration sensor) which detects acceleration in the vertical direction (Z axis direction).

Each section which configures the physical quantity sensor 100 will be described below in order in detail.

The material of the substrate 10, for example, is an insulating material such as glass. By setting, for example, both the insulating material such as glass as the substrate 10, and a semiconductor material such as silicon as the movable section 20, it is possible to easily electrically insulate the substrate 10 from the movable section 20, and it is possible to simplify the structure of the sensor. In a case where the substrate 10 is configured by glass, it is possible to provide a physical quantity sensor with higher sensitivity.

A concave section 11 is formed on the substrate 10. The movable section 20 and the linking sections 30 and 32 are provided above the concave section 11 with a gap therebetween. In the example shown in FIG. 1, a planar form of the concave section 11 (the form viewed from the Z axis direction) is a rectangular form. A post section 13 is provided on the bottom surface 12 of the concave section 11 (a surface of the substrate 10 which specifies the concave section 11).

In the example shown in FIG. 2 to FIG. 4, the post section 13 is provided integrally with the substrate 10. The post section 13 protrudes upward from (in the +Z axis direction) the bottom surface 12.

As shown in FIG. 3 and FIG. 4, in the present embodiment, the height of the post section 13 (the distance between an upper surface 14 of the post section 13 and the bottom surface 12) and the depth of the concave section 11 are equal.

The upper surface 14 of the post section 13 is joined to the support section 40. A cavity section 15 is formed on the upper surface 14 of the post section 13. A first wiring 60 is provided on a bottom surface 16 of the cavity section 15 (a surface of the post section 13 which specifies the cavity section 15).

Here, in the example shown in FIG. 2 to FIG. 4, the side surface of the concave section 11 (a side surface of the substrate 10 which specifies the concave section 11) and a side surface of the post section 13 are perpendicular to the bottom surface 12 of the concave section 11, but may be inclined with respect to the bottom surface 12.

The movable section 20 is displaceable about a support axis (first axis) Q. In detail, when acceleration is applied in the vertical direction (Z axis direction), the movable section 20 see-saw rocks with the support axis Q, which is determined by the linking sections 30 and 32, as a rotation axis (rock axis). The support axis Q is, for example, parallel to the Y axis. In the example shown in the drawings, the planar form of the movable section 20 is a rectangular form. The thickness of the movable section 20 (the size in the Z axis direction) is, for example, fixed.

The movable section 20 has a first mass section 20a and a second mass section 20b.

In planar view, the first mass section 20a is one out of two portions of the movable section 20 which is partitioned by the support axis Q (the portion which is positioned on the left side in FIG. 1).

In planar view, the second mass section 20b is the other out of the two portions of the movable section 20 which is partitioned by the support axis Q (the portion which is positioned on the right side in FIG. 1).

In a case where acceleration (for example, gravitational acceleration) is applied to the movable section 20 in the vertical direction, a rotational moment (a moment of force) is generated in each of the first mass section 20a and the second mass section 20b. Here, in a case where the rotational moment (for example, a counterclockwise direction rotational moment) of the first mass section 20a and the rotational moment (for example, a clockwise direction rotational moment) of the second mass section 20b are balanced, there is no change in inclination of the movable section 20, and it is not possible to detect acceleration. Accordingly, the movable section 20 is designed such that when acceleration is applied in the vertical direction, the rotational moment of the first mass section 20a and the rotational moment of the second mass section 20b are not balanced, and the movable section 20 is inclined at a predetermined angle.

In the physical quantity sensor 100, the mass sections 20a and 20b have different masses from each other since the support axis Q is displaced from the center (center of gravity) of the movable section 20, and the distance from the support axis Q to the leading end of the mass section 20a and that of the mass section 20b are different. That is, the one side of the movable section 20 (the first mass section 20a) and the other side of the movable section 20 (the second mass section 20b) with the support axis Q as the boundary therebetween, have different masses. In the example shown in the drawings, the distance from the support axis Q to an end surface 23 of the first mass section 20a is greater than the distance from the support axis Q to an end surface 24 of the second mass section 20b. In addition, the thickness of the first mass section 20a and the thickness of the second mass section 20b are equal. Accordingly, the mass of the first mass section 20a is greater than the mass of the second mass section 20b. In this manner, it is possible that the rotational moment of the first mass section 20a and the rotational moment of the second mass section 20b are not balanced when acceleration is applied in the vertical direction by the mass sections 20a and 20b having different masses from each other. Accordingly, it is possible that the movable section 20 is inclined at a predetermined angle when acceleration is applied in the vertical direction.

The movable section 20 is provided to be apart from the substrate 10. The movable section 20 is provided above the concave section 11. In the example shown in the drawings, a gap is provided between the movable section 20 and the substrate 10. In addition, the movable section 20 is provided to be apart from the support section 40 by means of the linking sections 30 and 32. Thereby, it is possible for the movable section 20 to see-saw rock.

The movable section 20 includes a first movable electrode 21 and a second movable electrode 22 that are provided, with the support axis Q as the boundary. The first movable electrode 21 is provided in the first mass section 20a. The second movable electrode 22 is provided in the second mass section 20b.

The first movable electrode 21 is a portion of the movable section 20 that overlaps with a first fixed electrode 50 in planar view. The first movable electrode 21 forms an electrostatic capacity C1 with the first fixed electrode 50. That is, the electrostatic capacity C1 is formed by the first movable electrode 21 and the first fixed electrode 50.

The second movable electrode 22 is a portion of the movable section 20 that overlaps with a second fixed electrode 52 in planar view. The second movable electrode 22 forms an electrostatic capacity C2 with the second fixed electrode 52. That is, the electrostatic capacity C2 is formed by the second movable electrode 22 and the second fixed electrode 52. In the physical quantity sensor 100, the movable electrodes 21 and 22 are provided in the movable section 20 by forming conductive material (impurity doped silicon) portions. Thus, the first mass section 20a functions as the first movable electrode 21 and the second mass section 20b functions as the second movable electrode 22.

In a state in which the movable section 20 shown in FIG. 2 for example is horizontally positioned, the electrostatic capacity C1 and the electrostatic capacity C2 are equal to each other. The positions of the movable electrodes 21 and 22 change according to the movement of the movable section 20. The electrostatic capacities C1 and C2 change according to the positions of the movable electrodes and 22. A predetermined potential is imparted to the movable section 20 via the linking sections 30 and 32 and the support section 40.

A through hole 25 which passes through the movable section 20 is formed in the movable section 20. Thereby, it is possible to reduce the influence of air (resistance of air) when the movable section 20 rocks. For example, a plurality of through holes 25 are formed. In the example shown in the drawings, the planar form of the through hole 25 is a rectangular form.

An opening section 26 which passes through the movable section 20 is provided in the movable section 20. In planar view, the opening section 26 is provided on the support axis Q. The linking sections 30 and 32 and the support section 40 are provided in the opening section 26. In the example shown in the drawings, the planar form of the opening section 26 is a rectangular form. The movable section 20 is connected to the support section 40 via the linking sections 30 and 32.

The linking sections 30 and 32 link the movable section 20 and the support section 40. The linking sections and 32 function as a torsion spring. Thereby, it is possible for the linking sections 30 and 32 to have strong resilience to torsional deformation, which is generated in the linking sections 30 and 32, since the movable section 20 see-saw rocks.

In planar view, the linking sections 30 and 32 are arranged on the support axis Q. The linking sections 30 and extend along the support axis Q. The first linking section 30 extends from the support section 40 in the +Y axis direction. The second linking section 32 extends from the support section 40 in the −Y axis direction.

The support section 40 is disposed in the opening section 26. In planar view, the support section 40 is provided on the support axis Q. A portion of the support section 40 is joined (connected) to the upper surface 14 of the post section 13. The support section 40 supports the movable section 20 via the linking sections 30 and 32. A connection region 46 to which the linking sections 30 and 32 are connected and which extends along the support axis Q, and a contact region 63 that is electrically connected to the first wiring 60, which is provided outside the connection region 46 in planar view and provided on the substrate, are provided in the support section 40.

The support section 40 has a first portion 41 and second portions 42, 43, 44, and 45. The support section 40 has a form in which the first portion 41 extends along a second axis R that intersects with (in detail, is orthogonal to) the support axis Q, and the second portions 42, 43, 44, and 45 extend from an end of the first portion 41. The second axis R is an axis which is parallel to the X axis.

The first portion 41 of the support section 40 extends while intersecting with (in detail, while being orthogonal to) the support axis Q. The first portion 41 is joined to the linking sections 30 and 32. In planar view, the first portion 41 is provided on the support axis Q and is apart from the substrate 10. That is, the portion on the support axis Q of the support section 40 is apart from the substrate 10. In the example shown in FIG. 1, the planar form of the first portion 41 is a rectangular form. The first portion 41 extends along the second axis R.

The connection region 46 is provided in the first portion 41 of the support section 40. In the example shown in FIG. 1, in planar view, the connection region 46 is a region of the support section 40 which is interposed by the linking sections 30 and 32. In the example shown in the drawings, the planar form of the connection region 46 is a rectangular form. At least a portion of the connection region 46 is not fixed to the substrate 10.

The second portions 42, 43, 44, and 45 of the support section 40 protrude (extend) from an end of the first portion 41. In the example shown in FIG. 1, the planar form of the second portions 42, 43, 44, and 45 is a rectangular form. The contact region 63 is provided in each of the second portions 42, 43, 44, and 45.

The second portions 42 and 43 of the support section 40 extend in opposite directions from each other along the support axis Q from one end of the first portion (in detail, the end in the −X axis direction). In the example shown in the drawings, the second portion 42 extends in the +Y axis direction from the one end of the first portion 41. The second portion 43 extends in the −Y axis direction from the one end of the first portion 41. A portion of the second portion 42 and a portion of the second portion 43 are joined to the post section 13.

The second portions 44 and 45 of the support section 40 extend in opposite directions from each other along the support axis Q from the other end of the first portion 41 (in detail, the end in the +X axis direction). In the example shown in the drawings, the second portion 44 extends in the +Y axis direction from the other end of the first portion 41. The second portion 45 extends in the −Y axis direction from the other end of the first portion 41. A portion of the second portion 44 and a portion of the second portion 45 are joined to the post section 13.

The support section 40 has an H-shape (substantially H-shape) planar form including the portions 41, 42, 43, 44, and 45 described above. That is, the first portion 41 configures a lateral bar in the H shape. The second portions 42, 43, 44, and 45 configure vertical bars in the H shape.

In addition, the movable section 20, the linking sections 30 and 32, and the support section 40 are integrally provided. In the example shown in the drawings, the movable section 20, the linking sections 30 and 32, and the support section 40 form one structure (silicon structure) 2. The movable section 20, the linking sections and 32, and the support section 40 are integrally provided by patterning one substrate (silicon substrate). The material of the movable section 20, the linking sections and 32, and the support section 40 is, for example, silicon to which conductivity is imparted by impurities such as phosphorus and boron being doped. In a case where the material of the substrate 10 is glass, and the material of the movable section 20, and the linking sections 30 and 32, and the support section 40 is silicon, the substrate 10 and the support section 40 are joined, for example, by anodic bonding.

In the physical quantity sensor 100, the structure 2 is fixed to the substrate 10 using one support section 40. That is, the structure 2 is fixed to the substrate 10 at one point (one support section 40). Accordingly, in comparison to a form in which, for example, the structure is fixed to the substrate at two points (two support sections), it is possible to reduce influence of stress, which is generated due to a difference between the coefficient of thermal expansion of the substrate 10 and the coefficient of thermal expansion of the structure 2, stress, which is applied to the apparatus during mounting, and the like on the linking sections 30 and 32.

The fixed electrodes 50 and 52 are provided on the substrate 10. In the example shown in the drawings, the fixed electrodes 50 and 52 are provided on the bottom surface 12 of the concave section 11. The first fixed electrode 50 is disposed so as to face the first movable electrode 21. The first movable electrode 21 is positioned above the first fixed electrode 50 via a gap. The second fixed electrode 52 is disposed so as to face the second movable electrode 22. The second movable electrode 22 is positioned above the second fixed electrode 52 via a gap. The area of the first fixed electrode 50 and the area of the second fixed electrode 52 are, for example, equal. The planar form of the first fixed electrode 50 and the planar form of the second fixed electrode 52 are, for example, symmetrical with respect to the support axis Q.

The material of the fixed electrodes 50 and 52 is, for example, aluminum, gold, or indium tin oxide (ITO). It is desirable for the material of the fixed electrodes 50 and 52 to be a transparent electrode material such as ITO, since it is possible to easily visually recognize foreign matter or the like on the fixed electrodes 50 and 52 by using the transparent electrode material as the fixed electrodes 50 and 52 in a case where the substrate 10 is a transparent substrate (glass substrate).

The first wiring 60 is provided on the substrate 10. The first wiring 60 has a wiring layer section 61 and a bump section 62.

The wiring layer section 61 of the first wiring 60 is connected to the first pad 70 and the bump section 62. In the example shown in the drawings, the wiring layer section 61 extends from the first pad 70 to the bump section 62 through a first groove section 17 which is formed on the substrate 10, the concave section 11, and the cavity section 15. In planar view, a portion of the wiring layer section in the cavity section 15 overlaps with the support section 40. In the example shown in the drawings, the planar form of the portion of the wring layer section 61 in the cavity section 15 is an H-shape (substantially H-shape). The material of the wiring layer section 61 is, for example, the same material as the fixed electrodes 50 and 52.

The bump section 62 of the first wiring 60 is provided on the wiring layer section 61. The bump section is connected to the wiring layer section 61 and the support section 40 in the contact region 63. That is, the contact region 63 is a region in which the first wiring 60 and the support section 40 are connected (come into contact). In further detail, the contact region 63 is a region of the bump section 62 (contact area) which is in contact with the support section 40. The material of the bump section 62 is, for example, aluminum, gold, or platinum.

The contact region 63 is disposed on a region other than the support axis Q. That is, the contact region 63 is disposed to be apart from the support axis Q. In planar view, for each of the one side (in detail, the +X axis direction side) and the other side (in detail, the −X axis direction side) with the support axis Q as the boundary, at least one contact region 63 is provided. In planar view, the contact region 63 is provided at both sides of the connection region 46 with the support axis Q as the boundary. In the example shown in the drawings, in planar view, four contact regions 63 are provided to overlap with the second portions 42, 43, 44, and 45 of the support section 40. That is, in planar view, the contact region 63 is provided to overlap with each end of the vertical bars of the support section 40 which have an H-shape (substantially H-shape). In the example shown in the drawings, the planar form of the contact region 63 is a rectangular form.

As shown in FIG. 3 and FIG. 4, the contact region 63 is positioned further above the upper surface 14 of the post section 13 (a joining surface of the post section 13 and the support section 40). In detail, when the silicon substrate is joined to the substrate 10 (described later in detail), the silicon substrate is recessed by being pressed by the bump section 62 of the first wiring 60, and the contact region 63 is positioned further above the upper surface 14 of the post section 13. For example, stress is generated in the support section 40 due to the support section 40 (the silicon substrate) being pressed by the bump section 62.

Here, although not shown in the drawings, the support section 40 may not be recessed, and the contact region 63 and the upper surface 14 of the post section 13 may be in the same position in the Z axis direction if the first wiring 60 and the support section 40 come into contact. That is, the contact region 63 and the upper surface 14 may have the same height. Even in such a form, stress is generated in the support section 40 due to the first wiring 60 and the support section 40 coming into contact.

The second wiring 64 is provided on the substrate 10. The second wiring 64 is connected to a second pad 72 and the first fixed electrode 50. In the example shown in the drawings, the second wiring 64 extends from the second pad 72 to the first fixed electrode 50 through a second groove section 18 and the concave section 11. The material of the second wiring 64 is, for example, the same material as the fixed electrodes 50 and 52.

The third wiring 66 is provided on the substrate 10. The third wiring 66 is connected to a third pad 74 and the second fixed electrode 52. In the example shown in the drawings, the third wiring 66 extends from the third pad 74 to the second fixed electrode 52 through a third groove section 19 and the concave section 11. The material of the third wiring 66 is, for example, the same material as the fixed electrodes 50 and 52.

The pads 70, 72, and 74 are provided on the substrate 10. In the example shown in the drawings, the pads 70, 72, and 74 are respectively provided in the groove sections 17, 18, and 19, and connected to the wirings 60, 64, and 66. In planar view, the pads 70, 72, and 74 are provided at positions which do not overlap with the lid 80. Thereby, even in a state in which the movable section 20 is accommodated within the substrate 10 and the lid 80, it is possible to detect the electrostatic capacities C1 and C2 using the pads 70, 72, and 74. The material of the pads 70, 72, and 74 is, for example, the same material as the fixed electrodes 50 and 52.

The lid 80 is provided on the substrate 10. The lid 80 is joined to the substrate 10. The lid 80 and the substrate 10 form a cavity 82 for accommodating the movable section 20. The cavity 82 has, for example, an inert gas (for example, nitrogen gas) atmosphere. The material of the lid 80 is, for example, silicon. In a case where the material of the lid 80 is silicon and the material of the substrate 10 is glass, the substrate 10 and the lid 80 are connected, for example, by anodic bonding.

Next, the operation of the physical quantity sensor 100 will be described.

In the physical quantity sensor 100, the movable section 20 rocks about the support axis Q according to the physical quantity of acceleration, angular velocity, and the like. Accompanying movement of the movable section 20, the distance between the first movable electrode 21 and the first fixed electrode 50, and the distance between the second movable electrode 22 and the second fixed electrode are changed. In detail, when, for example, vertically upward acceleration (in the +Z axis direction) is applied to the physical quantity sensor 100, the movable section 20 rotates in a counterclockwise direction, the distance between the first movable electrode 21 and the first fixed electrode 50 is reduced, and the distance between the second movable electrode 22 and the second fixed electrode 52 is increased. As a result, the electrostatic capacity C1 increases and the electrostatic capacity C2 decreases. In addition, when, for example, vertically downward acceleration (in the −Z axis direction) is applied to the physical quantity sensor 100, the movable section 20 rotates in a clockwise direction, the distance between the first movable electrode 21 and the first fixed electrode 50 is increased, and the distance between the second movable electrode 22 and the second fixed electrode 52 is reduced. As a result, the electrostatic capacity C1 decreases and the electrostatic capacity C2 increases.

In the physical quantity sensor 100, the electrostatic capacity C1 is detected using the pads 70 and 72, and the electrostatic capacity C2 is detected using the pads 70 and 74. Then, it is possible to detect the physical quantity of the orientation, degree, and the like of acceleration, angular velocity, and the like based on the difference between the electrostatic capacity C1 and the electrostatic capacity C2 (by a so-called differential detection method).

As described above, it is possible to use the physical quantity sensor 100 as an inertial sensor such as an acceleration sensor, a gyro sensor, or the like, and in detail, it is possible to use the physical quantity sensor 100 as, for example, an electrostatic capacitive-type acceleration sensor for measuring acceleration in the vertical direction (Z axis direction).

In the physical quantity sensor 100 described above, when a length of the movable section 20 in the longitudinal direction (X axis direction) of the movable section 20 is set as L and a length of the second mass section 20b in the longitudinal direction (X axis direction) of the movable section 20 is set as L2, the relationship of 0.2≦L2/L≦0.48 is satisfied. Particularly high detection sensitivity of the physical quantity sensor 100 is possible by satisfying such a relationship.

More specifically, in a state which is shown in FIG. 5, that is, in a state in which torque Ta due to acceleration and recovery torque Is of a torsion spring is balanced, it is possible to represent sensitivity Sz based on Equation (1) below.

$${S}_{z} = \frac{ɛ A}{{d}^{2}} L 1 θ \qquad ( 1 )$$

Equation 1: (∈: dielectric constant around the electrode, A: opposing areas of the movable section 20 and the fixed electrode, d: separation distance between the movable section 20 and the fixed electrode, θ: inclination of the movable section when 1G acceleration is applied)

Using Equation 1, the relationship between sensitivity and L2/L is indicated in a graph where d: 1.0 μm and 1.2 μm as shown in FIG. 6.

As understood from the graph in FIG. 6, it is possible for the physical quantity sensor 100 to be set to have particularly superior detection sensitivity by the relationship of 0.2≦L2/L≦0.48 being satisfied.

In particular, L and L2 more preferably satisfy the relationship of 0.25≦L2/L≦0.44, and further preferably satisfy the relationship of 0.35≦L2/L≦0.40. Thereby, it is possible to provide a physical quantity sensor with even higher sensitivity.

### Physical Quantity Sensor Manufacturing Method

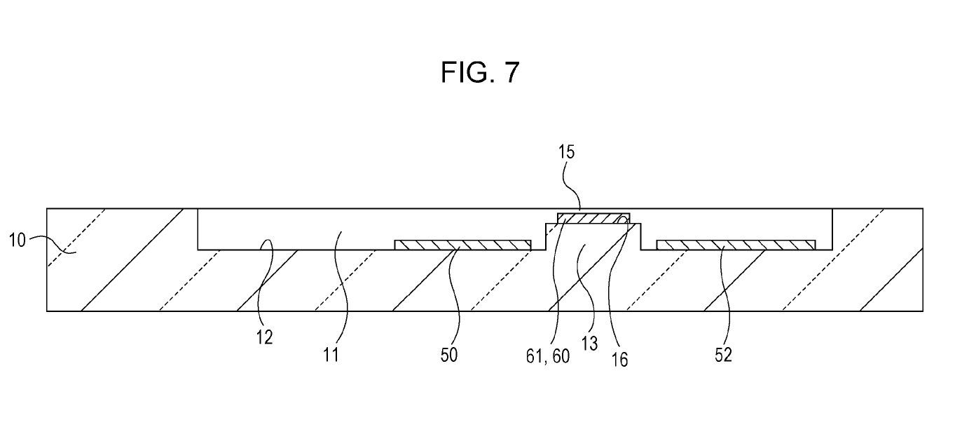

Next, the manufacturing method of the physical quantity sensor in FIG. 1 will be described with reference to the drawings. FIG. 7 to FIG. 9 are sectional diagrams schematically illustrating the manufacturing process of the physical quantity sensor 100 in FIG. 1, and correspond to FIG. 2.

As shown in FIG. 7, the post section 13 which is formed by the concave section 11 and the cavity section 15, and the groove sections 17, 18, and 19 (refer to FIG. 1) are formed by patterning, for example, a glass substrate. The patterning, for example, is performed by photolithography and etching. By the present process, it is possible to obtain a substrate 10 which has the concave section 11, the post section 13, and the groove sections 17, 18, and 19.

Next, the fixed electrodes 50 and 52 are formed on the bottom surface 12 of the concave section 11. Next, the wiring layer section 61 and the wirings 64 and 66 are formed on the substrate 10 (refer to FIG. 1). The wirings 64 and are formed so as to be respectively connected to the fixed electrodes 50 and 52. Next, the bump section 62 is formed on the wiring layer section 61 (refer to FIG. 3 and FIG. 4). Thereby, it is possible to form the first wiring 60. The bump section 62 is formed such that the upper surface thereof is positioned above the upper surface 14 of the post section 13. Next, the pads 70, 72, and 74 are formed so as to be respectively connected to the wirings 60, 64, and 66 (refer to FIG. 1).

The fixed electrodes 50 and 52, the wirings 60, 64, and 66, and the pads 70, 72, and 74 are formed, for example, by film formation using a sputtering method, or a chemical vapor deposition (CVD) method, and by patterning. The patterning, for example, is performed by photolithography and etching.

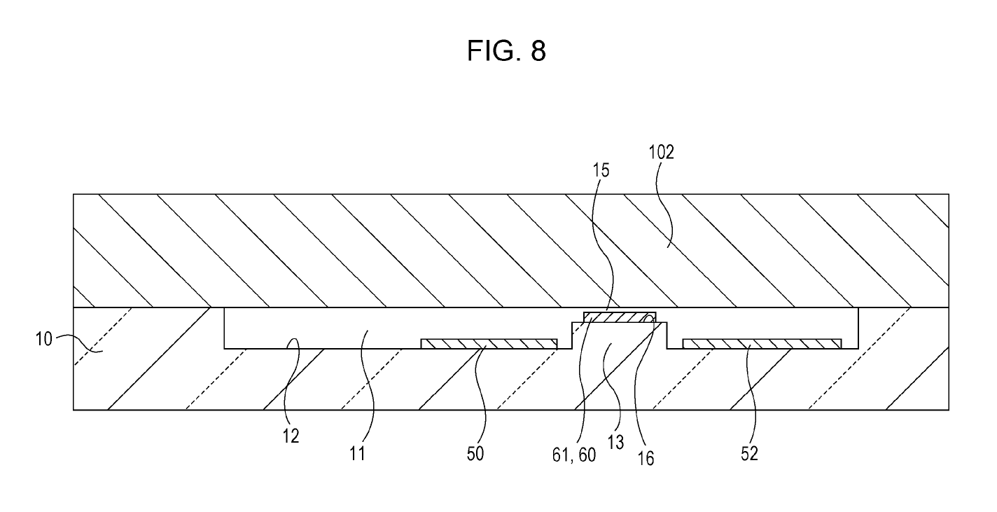

As shown in FIG. 8, for example, a silicon substrate 102 is joined to the substrate 10. The substrate 10 and the silicon substrate 102 are joined by, for example, anodic bonding. Thereby, it is possible to firmly join the substrate 10 and the silicon substrate 102. When the silicon substrate 102 is joined to the substrate 10, the silicon substrate 102 is recessed being pushed by, for example, the bump section 62 of the first wiring 60 (refer to FIG. 3 and FIG. 4). Thereby, stress is generated in the silicon substrate 102.

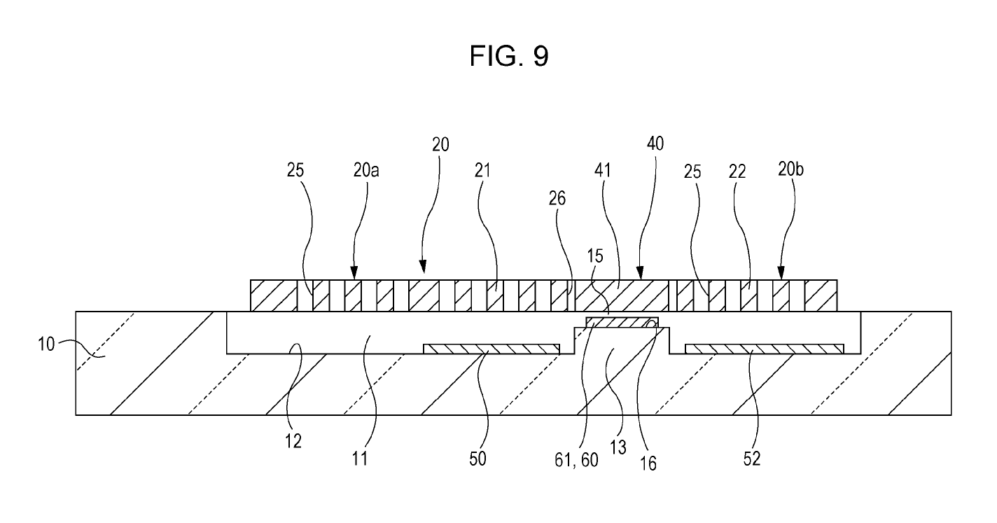

As shown in FIG. 9, after the silicon substrate 102 is ground and thinned by, for example, a grinding machine, the movable section 20, the linking sections 30 and 32, and the support section 40 are integrally formed by patterning in a predetermined form. The patterning is performed by photolithography and etching (dry etching), and more specifically, it is possible to use a Bosch process as an etching technique.

As shown in FIG. 2, the movable section 20 and the like are accommodated in the cavity 82, which is formed by the substrate 10 and the lid 80, by joining the lid 80 to the substrate 10. The substrate 10 and the lid 80 are joined by, for example, anodic bonding. Thereby, it is possible to firmly join the substrate 10 and the lid 80. It is possible to fill the cavity 82 with an inert gas by performing the process in an inert gas atmosphere.

It is possible to manufacture the physical quantity sensor 100 using the above process.

### Modification Example of Physical Quantity Sensor

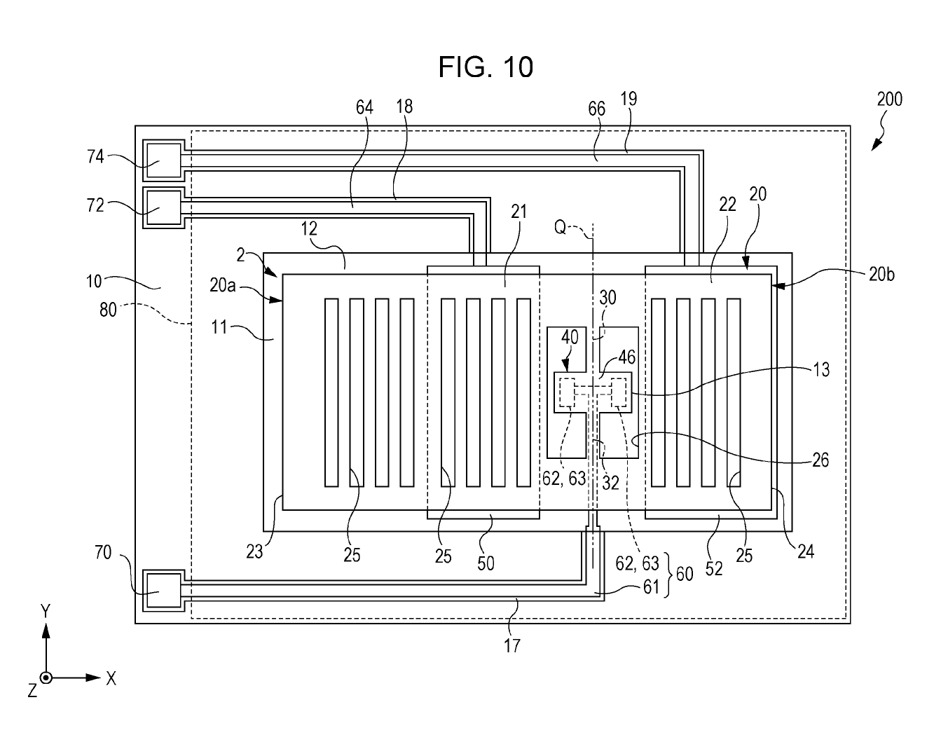

Next, a physical quantity sensor according to a modification example of the physical quantity sensor 100 will be described with reference to the drawings. FIG. 10 is a planar diagram schematically illustrating a physical quantity sensor 200 according to a modification example of a first embodiment. Here, for convenience of description, in FIG. 10, the lid 80 is illustrated as being transparent. In addition, in FIG. 10, the X axis, the Y axis, and the Z axis are illustrated as three axes which are orthogonal to one another.

Below, in the physical quantity sensor 200 according to the first modification example of the first embodiment, the same reference numerals as the first embodiment are given to portions which have the same function as the configuration members of the physical quantity sensor 100 in FIG. 1, and detailed description is omitted. The same also applies to a physical quantity sensor according to a second modification example of the first embodiment which is illustrated below.

As shown in FIG. 1, in the physical quantity sensor 100, the planar form of the support section 40 is an H-shape (substantially H-shape). In contrast to this, as shown in FIG. 10, in the physical quantity sensor 200, the planar form of the support section 40 is a square shape (rectangular form in the example shown in the drawings).

In planar view, in the physical quantity sensor 200, for each of the one side (in detail, the +X axis direction side) and the other side (in detail, the −X axis direction side) with the support axis Q as the boundary, one contact region 63 is provided.

In the physical quantity sensor 200, in the same manner as the physical quantity sensor 100, it is possible to achieve high detection sensitivity.

### Electronic Device

Next, an electronic device of the invention will be described.

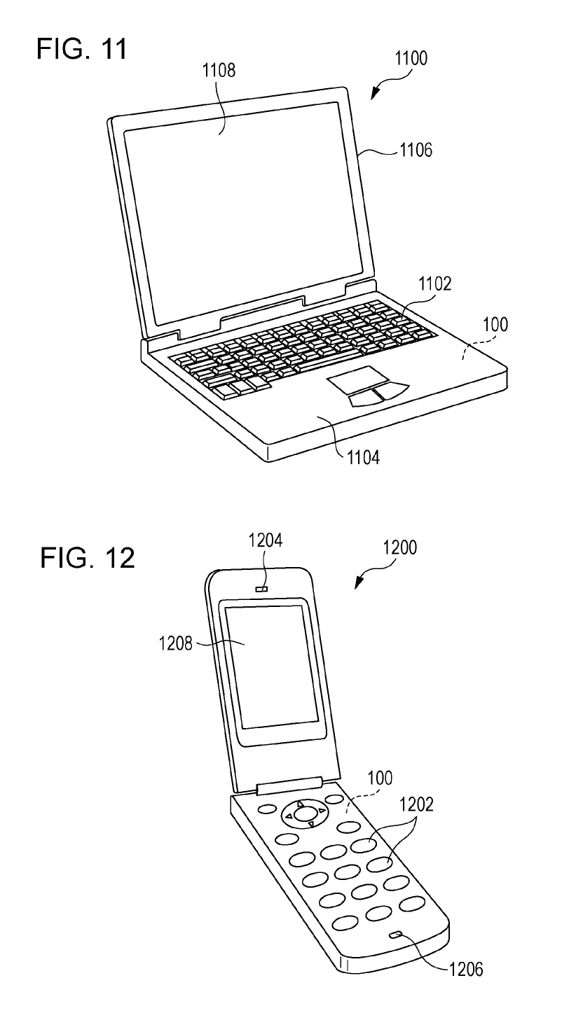

FIG. 11 is a perspective diagram illustrating a configuration of a mobile-type (or a notebook-type) personal computer to which the electronic device of the invention is applied.

As shown in FIG. 11, a personal computer 1100 is configured by a main body section 1104 which includes a keyboard 1102, and a display unit 1106 which includes a display section 1108, and the display unit 1106 is supported so as to be able to rotate via a hinge structure section with respect to the main body section 1104.

The physical quantity sensor 100 is built into the personal computer 1100.

FIG. 12 is a perspective diagram illustrating a configuration of a mobile phone (also including PHS) to which the electronic device of the invention is applied.

As shown in FIG. 12, a mobile phone 1200 includes a plurality of operation buttons 1202, a receiving port 1204, and a transmission port 1206, and a display section 1208 is disposed between the operation buttons 1202 and the receiving port 1204.

The physical quantity sensor 100 is built into the mobile phone 1200.

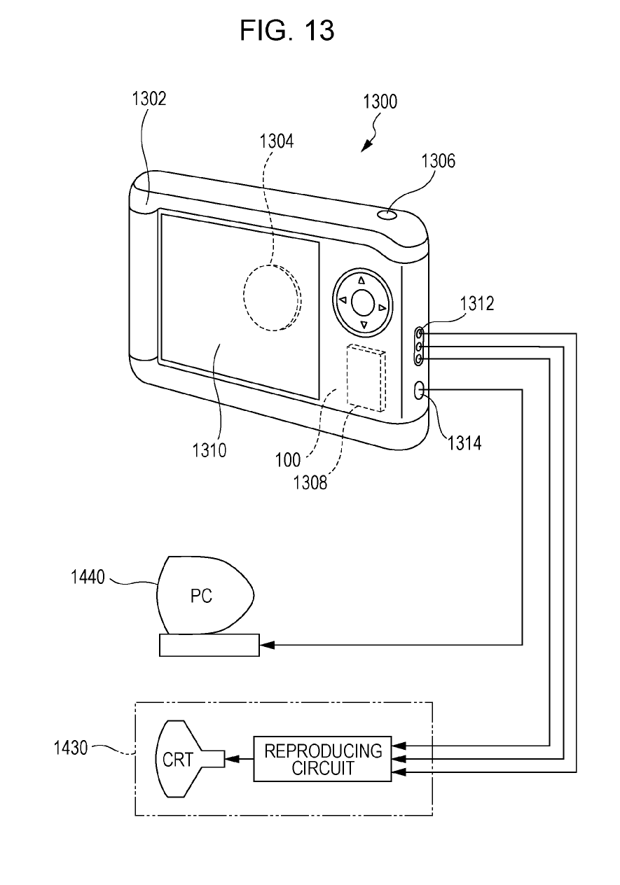

FIG. 13 is a perspective diagram illustrating a configuration of a digital still camera to which the electronic device of the invention is applied. Here, this drawing also illustrates the connection of an external device in a simplified manner.

A normal camera photosensitizes a silver halide photographic film with respect to an optical image of a subject. In contrast, a digital still camera 1300 generates an imaging signal (image signal) by photoelectric conversion of an optical image of a subject using an imaging element such as a charge coupled device (CCD).

The display section 1310 is provided on the rear surface of a case (body) 1302 in the digital still camera 1300, and is configured to perform display based on the imaging signal from the CCD, and the display section 1310 functions as a viewfinder which displays a subject using an electronic image.

In addition, a light-receiving unit 1304 which includes an optical lens (imaging optical system), a CCD, and the like is provided at the front surface side (the rear surface side in the drawing) of the case 1302.

When a subject image which is displayed on the display section 1310 is confirmed by a photographer and a shutter button 1306 is pressed down, the imaging signal of the CCD at the point in time is transferred and stored in a memory 1308.

In addition, a video signal output terminal 1312 and an input and output terminal 1314 for data communication are provided on a side surface of the case 1302 in the digital still camera 1300. Then, a television monitor 1430 is connected to the video signal output terminal 1312, or a personal computer 1440 is connected to the input and output terminal 1314 for data communication according to need. Furthermore, using a predetermined operation, the imaging signal which is stored in the memory 1308 is output to the television monitor 1430 or the personal computer 1440.

The physical quantity sensor 100 is built into the digital still camera 1300.

It is possible for such electronic devices 1100, 1200, and 1300 described above to achieve high detection sensitivity since the electronic devices include the physical quantity sensor 100.

Here, in addition to the personal computer illustrated in FIG. 11 (mobile-type personal computer), the mobile phone illustrated in FIG. 12, and the digital still camera illustrated in FIG. 13, it is also possible to apply the electronic device that includes the physical quantity sensor 100 to, for example, an ink jet-type discharging apparatus (for example, an ink jet printer), a laptop-type personal computer, a television, a video camera, a video tape recorder, various navigation devices, a pager, an electronic organizer (including those having a communication function), an electronic dictionary, an electronic calculator, an electronic game device, a head-mounted display, a word processor, a work station, a video phone, a television monitor for crime prevention, a pair of electronic binoculars, a POS terminal, medical equipment (for example, an electronic thermometer, a blood pressure meter, a blood glucose meter, an electrocardiographic measuring device, an ultrasonic diagnostic device, or an electronic endoscope), a fish finder, various measurement equipment, an instrument (for example, an instrument for a vehicle, an aircraft, a rocket, or a ship), posture control of a robot, a human, or the like, a flight simulator, and the like.

### Mobile Body

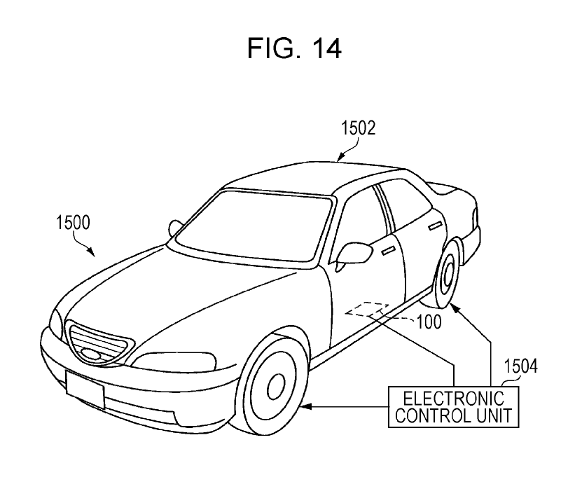

FIG. 14 is a perspective diagram schematically illustrating an automobile as an example of a mobile body of the invention.

The physical quantity sensor 100 is built into an automobile 1500. In detail, as shown in FIG. 16, an electronic control unit (ECU) 1504 with a built-in physical quantity sensor 100, which senses acceleration of the automobile 1500, and controls output from an engine is mounted on a vehicle body 1502 in the automobile 1500. In addition, it is possible to widely apply the physical quantity sensor 100 to a vehicle body posture control unit, an anti-lock brake system (ABS), an airbag, and a tire pressure monitoring system (TPMS).

It is possible for the automobile 1500 to achieve high detection sensitivity since the automobile 1500 includes the physical quantity sensor 100.

The embodiments and the modification examples described above are examples, and the invention is not limited thereto. For example, it is possible to appropriately combine each of the embodiments and each of the modification examples.

The invention includes configurations which are the same in practice as the configurations described in the embodiments (for example, configurations which have the same functions, method, and results, or configurations which have the same advantage and effects). In addition, the invention includes configurations where non-essential portions of the configuration described in the embodiments are substituted. In addition, the invention includes configurations which exhibit the same action effects and configurations where it is possible to realize the same advantage as the configuration described in the embodiments. In addition, the invention includes configurations which add known features to the configurations which are described in the embodiments.

The entire disclosure of Japanese Patent Application No. 2014-166925, filed Aug. 19, 2014 is expressly incorporated by reference herein.

What is claimed is:

1. A physical quantity sensor comprising:
a substrate;
a support section which is fixed to the substrate;
a movable section which is connected to the support section via a linking section and is able to rock with respect to the support section; and
fixed electrodes which are disposed on the substrate facing the movable section,
wherein the movable section has a first mass section which is provided on one side with respect to the linking section, a second mass section which is provided on the other side and has a smaller mass than the first mass section, a first movable electrode which is disposed in the first mass section, and a second movable electrode which is disposed in the second mass section,
the fixed electrodes include a first fixed electrode which is disposed facing the first mass section and a second fixed electrode which is disposed facing the second mass section, and
when a length of the movable section in the longitudinal direction of the movable section is set as L and a length of the second mass section in the longitudinal direction of the movable section is set as L2, a relationship of 0.2≦L2/L≦0.48 is satisfied.

2. The physical quantity sensor according to claim 1,
wherein the substrate is a glass substrate.

3. The physical quantity sensor according to claim 1,
wherein a relationship of 0.25≦L2/L≦0.44 is satisfied.

4. An electronic device comprising:
the physical quantity sensor according to claim 1.

5. An electronic device comprising:
the physical quantity sensor according to claim 2.

6. An electronic device comprising:
the physical quantity sensor according to claim 3.

7. A mobile body comprising:
the physical quantity sensor according to claim 1.

8. A mobile body comprising:
the physical quantity sensor according to claim 2.

9. A mobile body comprising:
the physical quantity sensor according to claim 3.
